(19) United States
(12) Patent Application Publication
(10) Pub. No.: US 2010/0320013 A1
(43) Pub. Date: Dec. 23, 2010

(54) WIDE TRACK ELECTRIC VEHICLE

(76) Inventors: Michael D. Tomberlin, Augusta, GA (US); Frank Andrew Johnson, Appling, GA (US)

Correspondence Address: MEHRMAN LAW OFFICE, P.C., P.O. Box 420797, ATLANTA, GA, 30342, US

(21) Appl. No.: 12/822,129

(22) Filed: Jun. 23, 2010

Related U.S. Application Data
(60) Provisional application No. 61/219,636, filed on Jun. 23, 2009.

(51) Int. Cl. B60K 1/00; B62D 61/00

(52) U.S. Cl. 180/65.1

(57) ABSTRACT

A wide track electric vehicle or low speed electric vehicle (LSV) with desirable attributes for street use, including a wheel base to wheel track ratio of not more than about 1.3 to 1, location of the passenger seats inside the wheels, and a turning radius of no more than 20 feet and preferably no more than 17.5 feet.

### REFERENCE TO RELATED APPLICATION

This application claim priority to U.S. Provisional Patent Application Ser. No. 61/21,636 filed Jun. 23, 2009, which in incorporated herein by reference.

### FIELD OF THE INVENTION

The present invention relates to low speed electric vehicles (LSVs) and, more particularly, relates to an wide track electric vehicle with desirable attributes for street use, including a wheel base to wheel track ratio of not more than about 1.3 to 1, location of the passenger seats inside the wheels, and a turning radius of 17.5 feet.

### BACKGROUND OF THE INVENTION

Each year over 150,000 electric golf carts are leased to golf courses in the United States. These leases are typically for four years. When a golf course renews its fleet of cars, the old cars are typically sold to individuals for private use in gated communities, private property and driven around town. The result is that over 150,000 used and new electric golf cars enter into the marketplace each year. The market is also growing in the low speed vehicle (LSV) segment where the same types of vehicles are converted to street legal status under Federal Motor Vehicle Safety Standards.

Typical golf carts have top speeds around 12 miles per hour, whereas street legal LSVs have top speeds in the range of 20 to 25 miles per hour. One of the biggest concerns of the private owner of a street legal LSV is suitability for road use including rollover stability at the faster speeds used on the roadways. As closed communities, neighborhoods, and localities grow and accept these vehicles, rollover safety and suitability for road use becomes an even greater concern for customers. As a result, there is a continuing need for more LSVs that are more suitable for road use including vehicles with improved rollover stability and other attributes suitable for street use.

### SUMMARY OF THE INVENTION

The present invention meets the needs described above in an electric motor vehicle or low speed vehicle (LSV) having desirable attributes for street use, including a wheel base to wheel track ratio of not more than about 1.3 to 1, location of the passenger seats inside the wheels, and a turning radius of not more than 20 feet and preferably not more than 17.5 feet.

### BRIEF DESCRIPTION OF THE DRAWINGS

FIG. 1 is a conceptual bottom view illustration of an electric vehicle showing the wheel base and wheel track and the location of the passenger seats with respect to the wheels of the vehicle.

FIG. 2 is a conceptual top view illustration of an electric vehicle showing a desired turning radius range.

### DETAILED DESCRIPTION

The present invention may be embodied in an electric vehicle or Low Speed Electric Vehicle (LSV) in compliance with the Federal Motor Vehicle Safety Standard 500 (“FMVSS500” codified at 49 CFR 571.500), such as the Tomberlin™ Anvil™. FMVSS500 requires that LSVs for street use have top speeds between 20 and 25 mph, which is significantly higher than the 12 mph top speed typically considered appropriate for golf course use. As a result, ordinary golf carts can feel somewhat unstable, particularly from a rollover standpoint, when operated at the higher top speeds required for street use by FMVSS500.

The present invention provides a wide track electric vehicle with a number of features that produce improved rollover stability and suitability for street use. These features include a wheel base to wheel track ratio of not more than about 1.3 to 1, location of the passenger seats axially inside the wheels, and a turning radius of not more than 20 feet and preferably not more than 17.5 feet.

Conventional golf carts and LSVs have wheel base to wheel track ratios significantly greater than 1.3, as show below:

| Wheelbase to | | |
|---|---|---|
| Wheel Track Ratio | Vehicle Male | Vehicle Model |
| 1.3 | Tomberlin | Anvil |
| 2.1 | Chrysler GEM | e4 |
| 1.9 | Club Car | Villager 4 |
| 2.9 | Club Car | Villager 6 |
| 1.9 | EZ-GO | Shuttle 2 + 2 |
| 2.7 | EZ-GO | Shuttle 6 |
| 2.2 | Colombia Par Car | SM-4 |

The Tomberlin Anvil, with its category leading interior width, can accommodate up to four forward facing seats separated in the front by a console. The wheelbase to wheel track ratio of the Tomberlin Anvil therefore represents a significant improvement over conventional golf carts and LSVs. In addition, the wheelbase to wheel track ratio of 1.3 to 1 allows the Tomberlin Anvil to be packed sideways (as opposed to lengthwise) in a conventional ocean shipping container, resulting in significant savings in shipping costs even though the vehicle has a wider wheel base than conventional vehicles in the golf cart and LSV categories.

In conventional golf carts and LSVs the seats are located over the wheel wells. The Tomberlin Anvil improves the rollover stability by locating the passenger seats inside the wheels. The Tomberlin Anvil also has a turning radius of not more than 20 feet, and preferably not more than 17.5 feet, allowing the vehicle to turn around in a typical neighborhood street without engaging reverse. The Tomberlin Anvil also has the ability to parallel park “front end in” into an ordinary automotive parking space of not les than 24 feet long and 9 feet wide without engaging reverse. The Tomberlin Anvil can also park perpendicular to the axis of this size parking space without sticking out into traffic.

The Tomberlin Anvil also has a number of other advantages over conventional golf carts and LSVs, including a solid mounted B Pillar to accommodate shoulder seat belts, which may be required for this category of vehicle in the future. The solid mounted B Pillars also provide the structure for housing side airbags. The wider wheel base provides the ability to have a 48 inch cargo carrier for hauling and work space, which is an advantage for commercial use not previously available in the electric vehicle category. The Tomberlin Anvil also has 16 inch wheels for improved ride, standard automotive service of the tires, a broad range of wheel accessories, and a variety of tire patterns for improved surface traction for differing road surfaces.

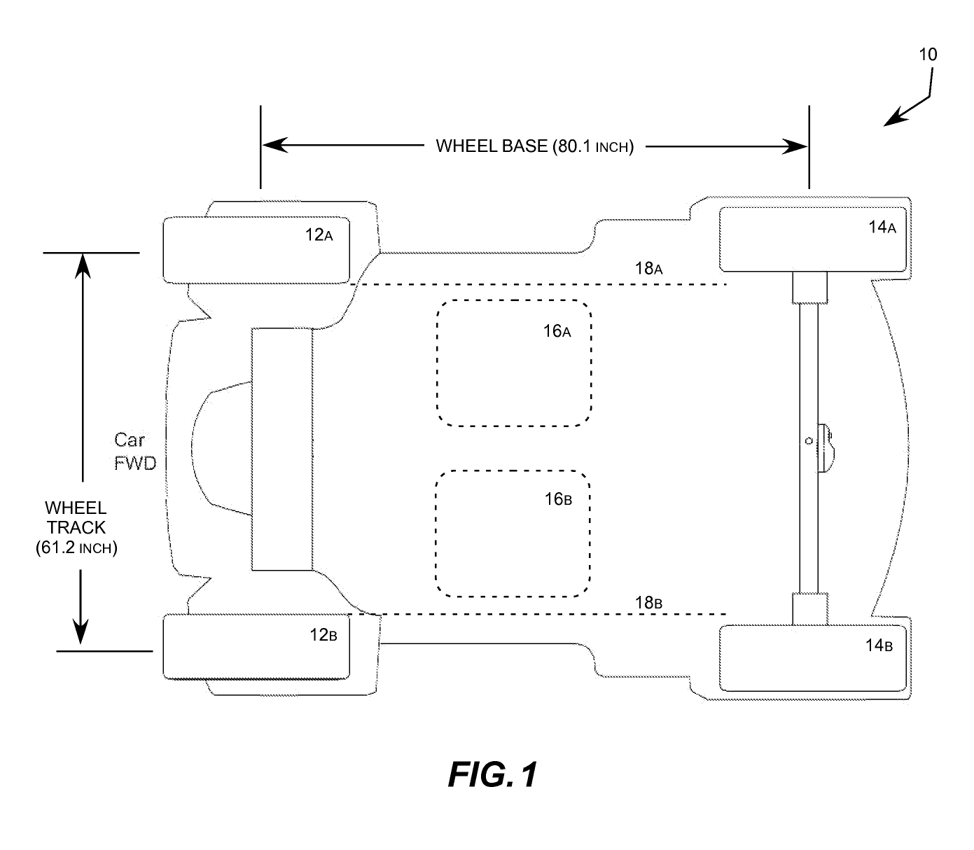

Turning now to the figures, FIG. 1 is a conceptual bottom view of an electric vehicle 10 showing the wheel base, the wheel track, and the location of the passenger seats with respect to the wheels of the vehicle. The electric vehicle 10 includes left and right front wheels 12A and 12B along with left and right rear wheels 14A and 14B. The electric vehicle 10 also includes passenger seats 16A and 16B, which are located axially inside the left wheels 12A and 14A, as represented by the inner wheel line 18A, and also axially inside the right wheels 12B and 14B, as represented by the inner wheel line 18B. For the present description, the term “axial direction” means perpendicular to the straight forward direction of travel of the vehicle and extending away from the center line of the vehicle. The “axial direction” also represents the axis of rotation of the wheels extending away from the center line of the vehicle when the vehicle is traveling straight. As a result, FIG. 1 shows a vehicle configuration in which the passenger seats 16A and 16B are located axially inside the wheels 12A-B and 14A-B, as represented by the inner wheel lines 18A and 18B.

The electric vehicle 10 has a wheel base of 80.1 inches extending from the axis of rotation of the front wheels 12A-B to the axis of rotation of the rear wheels 14A-B. The vehicle also has a wheel track of 61.2 inches extending from the center of the front left wheel 12A to the center of the front right wheel 12B. This produces a wheel base to wheel track ratio of approximately 1.3 to 1.

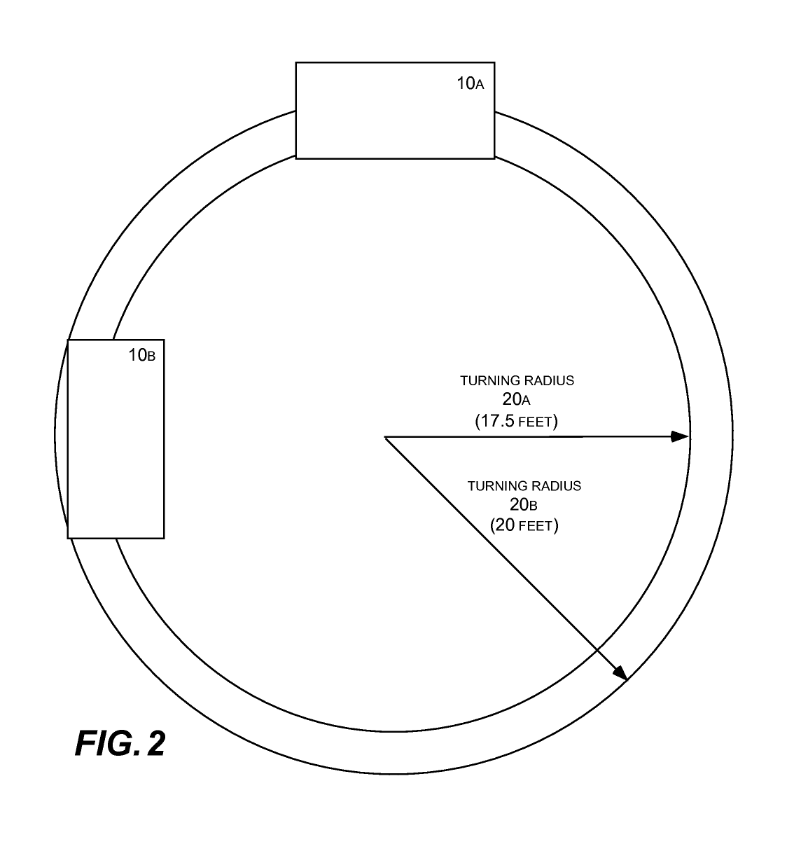

FIG. 2 is a conceptual illustration of an electric vehicle showing a desired turning radius range of not more than 20 feet and preferably not more than 17.5 feet. The electric vehicle 10A has a turning radius of about 20 feet and the electric vehicle 10B has a turning radius of about 17.5 feet.

The invention claimed is:

1. An electric motor vehicle configured for street use and comprising passenger seats, front wheels and rear wheels, having a wheel base defined as a distance between the front and the rear wheels and a wheel track defined as a distance between the left and right wheels, having a wheel base to wheel track ratio of not more than about 1.3 to 1.

2. The electric motor vehicle of claim 1, further having a turning radius of no more than 20 feet.

3. The electric motor vehicle of claim 1, further having a turning radius of no more than 17.5 feet.

4. The electric motor vehicle of claim 1, wherein the wheels rotate about an axial direction and the passenger seats are located axially inside the wheels.

5. The electric motor vehicle of claim 4, further having a turning radius of no more than 20 feet.

6. The electric motor vehicle of claim 5, further having a turning radius of no more than 17.5 feet.

7. An electric motor vehicle configured for street use, wherein the wheels rotate about an axial direction and the passenger seats are located axially inside the wheels.

8. The electric motor vehicle of claim 7, further having a turning radius of no more than 20 feet.

9. The electric motor vehicle of claim 8, further having a turning radius of no more than 17.5 feet.

10. An electric motor vehicle configured for street use having a turning radius of no more than 20 feet.

11. The electric motor vehicle of claim 10, further having a turning radius of no more than 17.5 feet.
